(19) United States
(12) Patent Application Publication
(10) Pub. No.: US 2025/0232888 A1
(43) Pub. Date: Jul. 17, 2025

(54) RADIUM ADSORBENT COMPOSITIONS, SYSTEMS, AND METHODS OF USING THE SAME

(71) Applicant: Stochastic Research Technologies LLC, Crystal Lake, IL (US)

(72) Inventor: Urmila Diwekar, Crystal Lake, IL (US)

(21) Appl. No.: 18/413,335

(22) Filed: Jan. 16, 2024

(51) Int. Cl. G21F 9/16; G21F 9/00; G21F 9/12

(52) U.S. Cl. CPC G21F 9/162; G21F 9/008; G21F 9/12

(57) ABSTRACT

Radioactive material adsorbing clay material effectively and efficiently removes radioactive material, namely radium, from aqueous fluids, thereby purifying the same. Methods of synthesizing and using the same are further provided.

### TECHNICAL FIELD

The present invention relates to radioactive material adsorbing clay material. Specifically, the structure of the clay material of the present invention effectively and efficiently removes radioactive material, namely radium, from aqueous fluids, thereby purifying the same. Methods of synthesizing and using the same are further provided.

### BACKGROUND

Water is often used in many industries, especially in oil and gas drilling and/or fracking processes within the oil and gas industries. As water is pumped into and/or out of the earth during these processes, the water is often contaminated with naturally occurring radioactive material (“NORM”), such as, for example, radioactive radium. Processed water, also known as “produced water,” from these industries cannot be released into the environment without causing environmental problems and are subject to environmental regulations for health and safety.

Specifically, hydraulic fracturing, known as “hydrofracking” or, simply, “fracking,” is the propagation of fractures in a rock layer by pressurized fluid, typically water. Induced fracking is a technique used to release petroleum, natural gas (including shale gas, tight gas and coal seam gas), or other substances for extraction, particularly from unconventional reservoirs, such as reservoirs that are not suitable for typical oil and gas drilling techniques. However, fracking can dislodge naturally occurring heavy metals and radioactive materials from deposits, and these substances return to the surface with flowback, known as wastewater, processed water, produced water, or brine. These naturally occurring radioactive materials are of concern because of their long half-lives. Radium, a common radionuclide often returned through the wastewater of the fracking process, can pose significant health hazards. For example, Radium-226 is a product of Uranium-238 decay and is the longest-lived isotope of radium with a half-life of 1601 years; next longest is Radium-228, a product of Thorium-232 breakdown, with a half-life of 5.75 years. Exposure to radium over a period of many years can result in an increased risk of some types of cancer, particularly lung and bone cancer. Higher doses of radium have been shown to cause effects on the blood (anemia), eyes (cataracts), teeth (broken teeth), and bones (reduced bone growth).

Several current approaches for managing industrial water contaminated with radioactive elements are available. Purifying techniques are utilized to separate radioactive elements from processed water, such as by using distillation/evaporation techniques, membrane separation techniques, such as reverse osmosis, and co-precipitation techniques. However, these solutions are energy and cost intensive and not very effective, often leading to relatively low yield of contaminated elements. Moreover, industrial purification processes suffer from mechanical issues, such as scaling, clogging, or failure of machinery. In addition, disposal of radioactive elements from contaminated industrial processed waters can be expensive and difficult due to the large amount of waste generated.

Another option for contaminated industrial processed water is to reinject the water into wells to drive the same deep underground, whereby natural processes may occur to filter the waters. Oil and gas wells, such as fracking wells, specifically, that pose contamination problems can also be isolated, but that eliminates production from those wells. Reinjection of contaminated waters can lead to geological issues, such as earthquakes and instability of surrounding rock. All solutions tend to lead to losses in revenue as oil and gas industries attempt to solve these problems. In addition, handling of radioactive materials can lead to safety and health issues for individuals.

A need, therefore, exists for improved radium absorbing adsorbents and methods of using the same. Specifically, a need exists for improved radium absorbing adsorbents that are efficient at removing radium from industrial processed waters and cost effective. More specifically, a need exists for improved radium absorbing adsorbents that are safe to use and handle.

In addition, a need exists for improved radium absorbing adsorbents that are easy and inexpensive to synthesize. Moreover, a need exists for improved radium absorbing adsorbents that are customizable for different applications. Further, a need exists for improved radium absorbing adsorbents that provides for cheaper and easier disposal than current solutions.

### SUMMARY OF THE INVENTION

The present invention relates to radioactive material adsorbing clay material. Specifically, the structure of the clay material of the present invention effectively and efficiently removes radioactive material, namely radium, from aqueous fluids, thereby purifying the same. Methods of synthesizing and using the same are further provided.

To this end, in an embodiment of the present invention, an adsorbent is provided. The adsorbent comprises: a chemical compound having the structural formula: (SiO₂)₁₁(Na₂O)₁₁(MgO)₉(Fe₂O₃)₄.

In an embodiment, the adsorbent is configured to adsorb radioactive material.

In an embodiment, the adsorbent is configured to adsorb radium.

In an embodiment, the adsorbent is configured to be combined with an aqueous fluid containing an amount of radioactive material.

In an embodiment, the radioactive material is radium.

In an embodiment, the adsorbent is a clay.

In an alternate embodiment of the present invention, a method of purifying an aqueous fluid is provided. The method comprises the steps of: providing an adsorbent comprising a chemical compound having the structural formula: (SiO₂)₁₁(Na₂O)₁₁(MgO)₉(Fe₂O₃)₄; mixing the adsorbent with an aqueous fluid, wherein the aqueous fluid comprises an amount of radioactive material therein; removing the radioactive material from the aqueous fluid with the adsorbent to form a solution of adsorbate solid comprising the adsorbent and the radioactive material; and separating the adsorbate solid forming purified aqueous fluid.

In an embodiment, the radioactive material is radium.

In an embodiment, the aqueous fluid is from an industrial process.

In an embodiment, the aqueous fluid is from a fracking process.

In an embodiment, the radioactive material is a naturally occurring radioactive material.

In an embodiment, the aqueous fluid is mixed with the sorbent in a tank.

In an embodiment, the aqueous fluid is introduced into the tank in a semi-continuous process.

In an alternate embodiment of the present invention, a system for purifying an aqueous fluid is provided. The system comprises: a mixing tank having an aqueous fluid input pipe, an adsorbate solid output pipe, and a purified aqueous fluid output pipe; a adsorbent disposed within the tank, the adsorbent comprising a chemical compound having the structural formula: (SiO₂)₁₁(Na₂O)₁₁(MgO)₉(Fe₂O₃)₄; wherein the tank is configured to allow an aqueous fluid to flow therein to mix with the adsorbent, wherein the aqueous fluid comprises an amount of radioactive material therein; wherein the adsorbent is configured to remove the radioactive material from the aqueous fluid with the adsorbent to form a solution of adsorbate solid comprising the adsorbent and the radioactive material; and wherein the tank is configured to separate the adsorbate solid forming purified aqueous fluid.

In an embodiment, the radioactive material is radium.

In an embodiment, the aqueous fluid is from an industrial process.

In an embodiment, the aqueous fluid is from a fracking process.

In an embodiment, the radioactive material is a naturally occurring radioactive material.

In an embodiment, the tank is configured to mix the aqueous fluid with the adsorbent.

In an embodiment, the tank is configured to mix the aqueous fluid with the adsorbent in a semi-continuous process.

It is, therefore, an advantage and objective of the present invention to provide improved radium absorbing adsorbents and methods of using the same.

Specifically, it is an advantage and objective of the present invention to provide improved radium absorbing adsorbents that are efficient at removing radium from industrial processed waters and cost effective.

More specifically, it is an advantage and objective of the present invention to provide improved radium absorbing adsorbents that are safe to use and handle.

In addition, it is an advantage and objective of the present invention to provide improved radium absorbing adsorbents that are easy and inexpensive to synthesize.

Moreover, it is an advantage and objective of the present invention to provide improved radium absorbing adsorbents that are customizable for different applications.

Further, it is an advantage and objective of the present invention to provide improved radium absorbing adsorbents that provides for cheaper and easier disposal than current solutions.

Additional features and advantages of the present invention are described in, and will be apparent from, the detailed description of the presently preferred embodiments and from the drawings.

### BRIEF DESCRIPTION OF THE DRAWINGS

The drawing FIGURES depict one or more implementations in accord with the present concepts, by way of example only, not by way of limitations. In the FIGURES, like reference numerals refer to the same or similar elements.

FIG. 1 illustrates a system for purifying aqueous fluids contaminated with radioactive material in an embodiment of the present invention.

### DETAILED DESCRIPTION OF THE PRESENTLY PREFERRED EMBODIMENTS

The present invention relates to radioactive material adsorbing clay material. Specifically, the structure of the clay material of the present invention effectively and efficiently removes radioactive material, namely radium, from aqueous fluids, thereby purifying the same. Methods of synthesizing and using the same are further provided.

In a preferred embodiment of the present invention, a clay comprising a sorbent may preferably have the following chemical structural formula:

(SiO₂)₁₁(Na₂O)₁₁(MgO)₉(Fe₂O₃)₄ (Formula 1)

The clay of Formula 1 may preferably be synthesized according to the following synthesis protocol. 9.48 g of Mg(NO₃)₂·6H₂O, 9.78 g of tetraethylorthosilicate (TEOS), 4.97 g of Na₂CO₃, and 5.54 g of FeCl₃ are each dissolved in 100.0 ml of deionized water. To the solution of TEOS, an equal amount of Ethyl alcohol is added. All solutions are mixed together to form a combined solution. Ammonia (NH₄OH) is added to the combined solution while mixing to form the precipitate of Formula 1. The precipitate is filtered and heated at 800° C. for 1.5 hours to dry and drive off water forming a sorbent for radioactive material, namely radium.

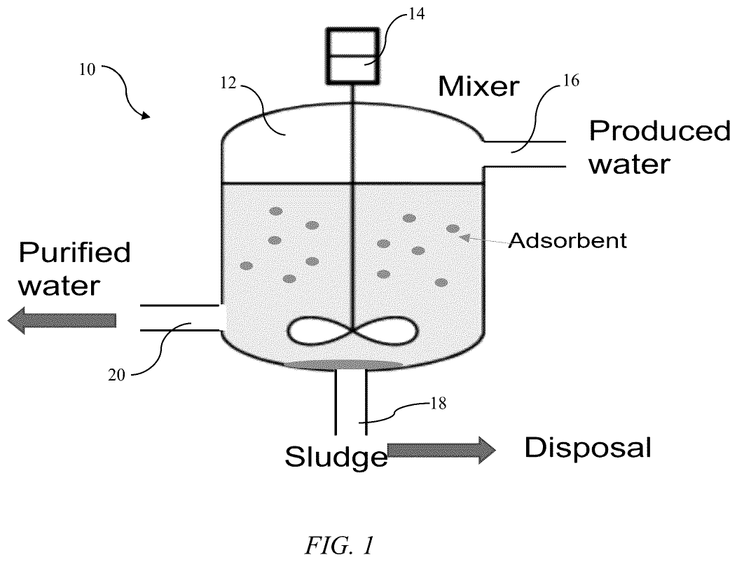

In an embodiment, an adsorbent formed from a clay of Formula 1 may be utilized to remove radioactive radium from an amount of an aqueous fluid, such as, for example, water in a semi-continuous process, as shown in system 10, illustrated in FIG. 1. The adsorbent formed from the clay of Formula 1 may be disposed within a tank 12 having a mixer 14. An amount of industrial, processed, or “produced” water having an amount of radioactive material, such as, for example, radium, present therein may be pumped into the tank 12 through an input pipe 16 and allowed to mix with the amount of the clay of Formula 1 disposed therein. As the clay of Formula 1 mixes with the industrial water pumped therein through the input pipe 16, the clay may adsorb the radioactive material and may form an adsorbate solid solution sludge that may be removed from the tank via the sludge output pipe 18 disposed on a bottom of the tank 12. Purified water may be removed from the tank via the purified aqueous fluid output pipe 20. The adsorbate solid solution sludge may be removed and disposed of, as is known in the art. The process 10 may be semi-continuous, in that the process may be halted to allow for the replacement and/or replenishment of the adsorbent so that the adsorbent does not become saturated with the radioactive material.

In an exemplary embodiment of the present invention, Table 1 shows five representative samples of water removed from the Permian Basin, home to one of the world's largest oil fields. The samples had radium concentrations that ranged between 1584.5 and 3955.4 picocuries per liter (pCi/l). Current regulations specify that the acceptable “safe” concentration of naturally occurring radioactive material (“NORM”) in groundwater is 30 pCi/l or less. For drinking water, the acceptable concentration of NORM is 5 pCi/l or less. The following chart shows the amount of NORM within the five representative samples after treatment with varying concentrations of the clay of Formula 1. Each sample showed undetectable levels of NORM after treatment with the clay of Formula 1, no matter the concentration of the clay of Formula 1:

TABLE 1

| Formula 1 (g/l) | NORM, pCi/l | % Removal |
|---|---|---|
| 20 | Not detected | 100 |
| 10 | Not detected | 100 |
| 5 | Not detected | 100 |
| 2 | Not detected | 100 |
| 1.5 | Not detected | 100 |

Table 2 shows a comparison of the adsorbent of Formula 1 compared against other common adsorbents for removal of radium from aqueous fluids. Again, these materials demonstrate the amount of the adsorbent required to adsorb concentrations of radium from water samples removed from the Permian Basin, which had radium concentrations that varied between 1584.5 and 3955.4 picocuries per liter (pCi/l).

TABLE 2

| | | Amount required |
|---|---|---|
| | | to adsorb Radium, |
| Adsorbent | Chemical Structure | M₀ (g/mol) |
| Kaolinite | (Al₂O₃)(SiO₂)₂(H₂O) | 222.1 |
| Montmorillonite | (Na₂O)(MgO)₂(Fe₂O₃)(Al₂O₃)(SiO₂)₄•2H₂O | 786.4 |
| Nontronite | (Na₂O)(Fe₂O₃)(Al₂O₃) SiO₂)₄•2H₂O | 665.9 |
| Glauconite | (K₂O)(MgO)₂(Fe₂O₃)(Al₂O₃)₂(SiO₂)₄ | 778.7 |
| Clinoptilolite | (SiO₂)₁₁(Na₂O)(K₂O)(Al₂O₃)₃(SiO₂)₃₀•24H₂O | 2320.6 |
| Formula 1 | (SiO₂)₁₁(Na₂O)₁₁(MgO)₉(Fe₂O₃)₄ | <5.0 |

Thus, the comparison data shown in Table 2 illustrates that it only requires less than 5.0 g/mole of the adsorbent of the Formula 1 to achieve the same or similar results of radium adsorption as the other known adsorbent clays, which require orders of magnitude more adsorbent material to achieve the same or similar results.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

What is claimed is:

1. An adsorbent comprising:
a chemical compound having the structural formula:
(SiO₂)₁₁(Na₂O)₁₁(MgO)₉(Fe₂O₃)₄.

2. The composition of claim 1 wherein the adsorbent is configured to adsorb radioactive material.

3. The composition of claim 1 wherein the adsorbent is configured to adsorb radium.

4. The composition of claim 1 wherein the adsorbent is configured to be combined with an aqeuous fluid containing an amount of radioactive material.

5. The composition of claim 4 wherein the radioactive material is radium.

6. The composition of claim 1 wherein the adsorbent is a clay.

7. A method of purifying water comprising the steps of:
providing an adsorbent comprising a chemical compound having the formula:
(SiO₂)₁₁(Na₂O)₁₁(MgO)₉(Fe₂O₃)₄;
mixing the adsorbent with an aqeuous fluid, wherein the aqueous fluid comprises an amount of radioactive material therein;
removing the radioactive material from the aqueous fluid with the adsorbent to form a solution of adsorbate solid comprising the adsorbent and the radioactive material; and
separating the adsorbate solid forming purified aqueous fluid.

8. The method of claim 7 wherein the radioactive material is radium.

9. The method of claim 7 wherein the aqueous fluid is from an industrial process.

10. The method of claim 7 wherein the aqueous fluid is from a fracking process.

11. The method of claim 7 wherein the radioactive material is a naturally occurring radioactive material.

12. The method of claim 7 wherein the aqueous fluid is mixed with the adsorbent in a tank.

13. The method of claim 12 wherein the aqeuous fluid is introduced into the tank in a semi-continuous process.

14. A system for purifying an aqueous fluid comprising:
a mixing tank having an aqueous fluid input pipe, an adsorbate solid output pipe, and a purified aqueous fluid output pipe;
an adsorbent disposed within the tank, the adsorbent having the formula:
(SiO₂)₁₁(Na₂O)₁₁(MgO)₉(Fe₂O₃)₄;
wherein the tank is configured to allow an aqueous fluid to flow therein to mix with the adsorbent, wherein the aqueous fluid comprises an amount of radioactive material therein;
wherein the adsorbent is configured to remove the radioactive material from the aqueous fluid with the adsorbent to form a solution of adsorbate solid comprising the adsorbent and the radioactive material; and
wherein the tank is configured to separate the adsorbate solid forming purified aqueous fluid.

15. The system of claim 14 wherein the radioactive material is radium.

16. The system of claim 14 wherein the aqueous fluid is from an industrial process.

17. The system of claim 14 wherein the aqueous fluid is from a fracking process.

18. The system of claim 14 wherein the radioactive material is a naturally occurring radioactive material.

19. The system of claim 14 wherein the tank is configured to mix the aqueous fluid with the adsorbent.

20. The system of claim 19 wherein the tank is configured to mix the aqueous fluid with the adsorbent in a semi-continuous process.
